(19) United States
(12) Patent Application Publication
(10) Pub. No.: US 2020/0214914 A1
(43) Pub. Date: Jul. 9, 2020

(54) A VEHICULAR LIFT

(71) Applicant: MCELMEEL MOBILITY SERVICES LIMITED, ARMAGH (GB)

(72) Inventor: MARTIN MCELMEEL, ARMAGH (GB)

(21) Appl. No.: 16/628,933

(22) PCT Filed: Jul. 9, 2018
(86) PCT No.: PCT/EP18/68583

§ 371 Date: Jan. 6, 2020

(30) Foreign Application Priority Data
Jul. 7, 2017 (GB) 1710998.4
Jul. 7, 2017 (GB) 1711009.9

(51) Int. Cl. A61G 3/08; A61G 3/06

(52) U.S. Cl. CPC A61G 3/0808; A61G 3/062; B60N 2/245; A61G 3/063; A61G 3/061

(57) ABSTRACT

A vehicular lift comprising a support member and an arrangement for securing an object to the support member, the support member being moveable between a loading position outside of a vehicle and a home/transit position inside the vehicle. The arrangement for securing holds the object securely in place as the support means moves between the loading position and the home/transit position.

The present invention relates to a vehicular lift. More specifically, the present invention relates to an improved vehicular lift for use with a vehicle.

Vehicular lifts for wheelchairs and the like are known and widely used. With conventional vehicular lifts an operator is required to first push the wheelchair and/or other similar object into position upon a lift platform surface. The vehicular lift subsequently maneuvers the wheelchair into the vehicle. While conventional vehicular lifts fulfil the requirement for the ease of entry of a wheelchair into a vehicle, they present an operator with a cumbersome and time consuming process to fasten the wheelchair user safely into position within the vehicle for transport. Once the occupied wheelchair is within the vehicle the operator must also enter into the vehicle usually from the side to reach across the wheelchair user to safely fasten them in the vehicle. An operator must secure the wheelchair and the wheelchair user from both sides of the vehicle.

It is an object of the present invention to mitigate this cumbersome and time-consuming process of wheelchair securement within a vehicle by providing an improved vehicular lift.

Accordingly, the present invention provides a vehicular lift comprising a support means and a means for securing an object to the support means, the support means being moveable between a loading position outside of a vehicle and a home/transit position inside the vehicle.

Advantageously, the vehicular lift means that there is no requirement to secure the object to the vehicle after the support means of the vehicular lift has been moved into the home/transit position as the object such as a wheelchair has been secured for transport outside the vehicle in the loading position. This significantly reduces the workload on the person assisting the person in the wheel chair and is a significant advantage as the person assisting is no longer required to climb into the vehicle often from the side and apply additional restraints within a tight space around an awkward shaped object where the head height of the vehicle requires the assistant to be bent over for the entire duration of their time in the vehicle. It is often the case that the assistant is elderly helping a spouse or sibling and so this clambering into and out of adapted vehicles while crouched over as well as bending and pulling restraint mechanism are extremely difficult tasks.

Preferably, the means for securing holds the object securely in place as the support means moves between the loading position and the home/transit position.

Ideally, the support means comprises a support surface.

Preferably, the support means comprises one or more fork lift tongues or similar lifting assembly.

Ideally, the means for securing is the primary means for securing the object in place within the vehicle.

Preferably, additional means for securing are not required in the vehicle to secure the object in place within the vehicle.

Ideally, the means for securing comprises one or more restraining means.

Preferably, the restraining means being operable to releasably secure the object to the support means.

Preferably, the restraining means being operable to releasably secure the object to one or more locations on the support means.

Ideally, the one or more locations on the support means are spaced apart from one another.

Preferably, the one or more locations comprises two locations located at or about opposed end portions of the support means.

Ideally, the opposed end portions of the support means are the front and rear end portions of the support means.

Preferably, the restraining means being operable to releasably secure the object to the support means, the restraining means comprising mechanical fastening means provided between the support means and the object.

Ideally, the mechanical fastening means comprises quick release mechanical fastening means.

Ideally, the mechanical fastening means comprising anchor components located at two/each corners of the support means. Advantageously, this avoids any collisions between the object/wheel chair and the anchor components during placing the wheel chair onto the support means.

Preferably, the mechanical fastening means comprises a wheel chair docking station.

Ideally, the support means comprises two or more births for supporting two or more objects such as wheel chairs.

Ideally, the restraining means comprise one or more of belts, ropes, cords, and chains.

Preferably, the restraining means comprises an object restraining means for restraining the object to the support means.

Preferably, the object restraining means comprises a plurality of one or more of belts, ropes, cords, and chains or any other suitable mechanical fastening arrangement for restraining the object to the anchor components of the support means.

Ideally, the restraining means comprises a person restraining means for restraining a person within the object.

Preferably, the vehicular lift further comprises an upstanding post attached to the support means.

Ideally, the restraining means comprises an upstanding post attached to the support means.

Ideally, the person restraining means extends from a portion of the upstanding post to the support means, the person restraining means being operable to releasably secure the person in the object to the support means.

Preferably, the person restraining means extends from a top end portion of the upstanding post to the support means, the person restraining means being operable to releasably secure the person in the object to the support means.

Ideally, the person restraining means comprises a seat belt arrangement.

Preferably, the seat belt arrangement being operable between the upstanding post and the support means.

Ideally, the seat belt arrangement having at least one reel fastened to a portion of the upstanding post, the reel component having a belt wound thereon with at least one tongue mounted on the belt, and a buckle component having a first end fastened to the support means on an opposite side of the support means to the upstanding post and a second free end for receiving the tongue.

Preferably, the seat belt arrangement has a second buckle component mounted lower down on the upstanding post or on the same side of the support means to the upstanding post.

Ideally, the seat belt arrangement has a second tongue component mounted on the belt for engagement with the second buckle for creating a three point seat belt arrangement.

Ideally, the upstanding post is located at or about the rear end portion of the support surface.

Preferably, the seat belt arrangement having a second reel fastened to a portion of the upstanding post or on the same side of the support means to the upstanding post.

Preferably, the vehicular lift further comprises a lifting mechanism, the lifting mechanism being operable to raise and/or lower the support means.

Ideally, the lifting mechanism is operable to raise the support means from the loading position and/or lower the support means towards the loading position.

Ideally, the vehicular lift has a fixed component mounted on the movable chassis and a movable component mounted to the support means.

Preferably, the vehicular lift has an actuator with a first part fixed on the fixed component and a second part coupled to the movable component mounted to the support means.

Preferably, the vehicular lift further comprises a displacement mechanism, the displacement mechanism being operable to move the support means into/out of the vehicle.

Ideally, the displacement mechanism being operable to move the support surface towards and away from the home/transit position.

Preferably, the displacement mechanism comprises one or more rails attachable to the vehicle.

Ideally, the one or more rails are attachable to the chassis of the vehicle.

Preferably, the one or more rails are integrally formed with the chassis of the vehicle.

Ideally, the one or more rails are releasably attachable to the chassis of the vehicle or the floor surface.

Preferably, the one or more rails comprise two spaced apart rails.

Ideally, the displacement mechanism comprises a movable support platform.

Preferably, the displacement mechanism having means for movably mounting the movable support platform on the pair of spaced apart rails formed/attached with the chassis of the vehicle.

Ideally, the movable mounting means comprising bearing means operable between the movable support platform and the pair of spaced apart rails.

Preferably, the bearing means allowing the movable support platform to move between a position inside and outside of the vehicle.

Ideally, the movable mounting means comprises a pair of slidable rails operably coupled to the fixed rails via the bearing means.

Preferably, the pair of slidable rails have a pair of mutually opposing channels for receiving a pair of carriage means/wheels or rollers with the movable support platform being operably coupled to the carriage means/wheels or rollers.

Ideally, the movable support platform is mechanically coupled to the carriage means by a movable chassis.

Ideally, the movable chassis is provided by a cross member beam.

Ideally, the cross member beam comprises a plate member.

Preferably, the carriage means are movably/rotatably mounted at or about the four corners of the cross member beam.

Ideally, the carriage means comprises four rollers/roller wheels, two of which are formed for rolling along each mutually opposing channel of the slidable rails.

Preferably, the channels of the movable rails allow the carriage means of the movable support platform to move relative to both the fixed rails and the movable rails. Advantageously, this provides additional travel for the movable support platform whilst avoiding overextension and thus additional stresses being applied to the displacement mechanism.

Ideally, the lifting mechanism is operable between the movable support platform and the rails.

Preferably, the lifting mechanism is operable between the movable support platform and the carriage means.

Ideally, the lifting mechanism is operable between the movable support platform and the movable chassis.

Preferably, the lifting mechanism is operable between the movable support platform and the cross member beam.

Ideally, the vehicular lift is attachable to a rear end of the vehicle.

Preferably, the vehicular lift is attachable to the inside of the vehicle.

Preferably, the home/transit position is inside a rear end compartment of the vehicle.

Ideally, the vehicle is a motor vehicle.

Preferably, the motor vehicle is a car, truck, sports utility vehicle (SUV), passenger van, commercial van, bus, pick up, lorry, boat or ship.

Ideally, the object is a wheel chair, mobility scooter, pram, pushchair, bicycle, motorbike, tricycle or quadbike.

Alternatively, the object comprises goods for transport.

Preferably, the wheelchair is an occupied wheelchair.

Ideally, when in the loading position, the support means is generally level with the ground.

Preferably, when in the home/transit position, the support means is generally level with the floor of the vehicle.

Ideally, the vehicular lift comprises a drive means for moving the support means between the outside and the inside the vehicle.

Preferably, the vehicular lift comprises a drive means for moving the support means between the outside and the inside the vehicle via the displacement means.

In one embodiment, the drive means comprises a chain and preferably a rigid chain drive system. The chain is of the type where adjacent links in the chain form a rigid rod when they extend in alignment with one another and they break back into independently movable links when they are bent out of alignment with one another via a mechanism for steering the links out of a rectilinear path of travel into a curvilinear path of travel.

Ideally, the chain is operably coupled between the support means and a housing for the chain.

In this embodiment, the drive means comprises a motor and gearbox for dispensing a chain out of the housing to drive the support means out of the vehicle and for reeling the chain back into the housing to pull the support means back into the vehicle.

Ideally, the motor and gearbox are disposed at or about or within the housing.

Ideally, the motor is an electric motor powered by the battery of the vehicle.

In a second embodiment, the drive means comprises a double acting hydraulic ram assembly.

In this embodiment, the drive means has a hydraulic ram operably coupled to each movable rail movably mounted on its corresponding fixed rail. In this way, the movable rails are moved relative to the fixed rails by operation of the hydraulic ram.

In this embodiment, a secondary actuator is operably coupled between the movable rails and the movable chassis.

Preferably, the secondary actuator comprises a driven toothed wheel mounted on the movable chassis and a plurality of slots formed along the movable rails for receiving teeth of the drive wheel for driving the movable chassis along the movable rails.

Ideally, the double acting hydraulic cylinder assembly is a multi-stage double acting hydraulic cylinder assembly, most preferably a six stage double acting hydraulic cylinder assembly.

Ideally, a portion of the support means comprises an actuatable ramp section.

Preferably, the actuatable ramp section is pivotally moveable to adjust the angle of the ramp with respect to the support surface.

Ideally, when in the home/transit position, the vehicular lift is entirely contained within the vehicle.

Accordingly, the present invention provides a vehicle comprising a compartment, the vehicle further comprising a vehicular lift, the vehicular lift comprising a support means and a means for securing an object to the support means, the support means being moveable between a loading position outside of the vehicle and a home/transit position inside the compartment of the vehicle.

The present invention also relates to a displacement mechanism. More specifically, the present invention relates to a displacement mechanism for loading and unloading goods for transport, mostly heavy goods. A large amount of goods for transport are now above the safe lifting weight for a single person and so more and more goods require mechanical assistance to be loaded and unloaded into and from containers.

It is an object of the present invention to mitigate the problems associated with loading and unloading goods into and from a container.

According to a further aspect of the invention, the present invention provides a displacement mechanism for moving a load from outside a container to inside a container, the displacement mechanism having a fixed arrangement and a movable arrangement movably mounted on the fixed arrangement, the movable arrangement having a support means operably engaged with the movable arrangement, the displacement mechanism being operable to move the support means into/out of a container.

Ideally, the displacement mechanism being operable to move the support means towards and away from a home/transit position.

Preferably, the displacement mechanism comprises one or more rails attachable to the container.

Ideally, the one or more rails are attachable to the chassis/floor/support structure of the container.

Preferably, the one or more rails are integrally formed with the chassis/floor/support structure of the container.

Ideally, the one or more rails are releasably attachable to the chassis/floor/support structure of the container.

Preferably, the one or more rails comprise two spaced apart rails.

Ideally, the support means of the displacement mechanism comprises a movable support platform.

Preferably, the displacement mechanism having means for movably mounting the movable support platform on the pair of spaced apart rails formed/attached with the chassis/floor/support structure of the container.

Ideally, the movable mounting means comprising bearing means operable between the movable support platform and the pair of spaced apart rails.

Preferably, the bearing means allowing the movable support platform to move between a position inside and outside of the container.

Ideally, the movable mounting means comprises a pair of slidable rails operably coupled to the fixed rails via the bearing means.

Preferably, the pair of slidable rails have a pair of mutually opposing channels for receiving a pair of carriage means/wheels or rollers with the movable support platform being mounted on the carriage means/wheels or rollers.

Ideally, the movable support platform is mechanically coupled to the carriage means by a movable chassis.

Ideally, the movable chassis is provided by a cross member beam.

Ideally, the cross member beam comprises a plate member.

Preferably, the carriage means are movably/rotatably mounted at or about the four corners of the cross member beam.

Ideally, the carriage means comprises four rollers/roller wheels, two of which are formed for rolling along each mutually opposing channel of the slidable rails.

Preferably, the channels of the movable rails allow the carriage means of the movable support platform to move relative to both the fixed rails and the movable rails. Advantageously, this provides additional travel for the movable support platform whilst avoiding overextension and thus additional stresses being applied to the displacement mechanism.

Ideally, the support means comprises a means for securing an object to the support means, the support means being moveable between a loading position outside of a container and a home/transit position inside the container.

Preferably, the means for securing holds the object securely in place as the support means moves between the loading position and the home/transit position.

Ideally, the support means comprises a support surface.

Preferably, the support means comprises one or more fork lift tongues or similar lifting assembly.

Ideally, the means for securing is the primary means for securing the object in place within the container.

Preferably, additional means for securing are not required in the container to secure the object in place within the container.

Ideally, the means for securing comprises one or more restraining means.

Preferably, the restraining means being operable to releasably secure the object to the support means.

Preferably, the restraining means being operable to releasably secure the object to one or more locations on the support means.

Ideally, the one or more locations on the support means are spaced apart from one another.

Preferably, the one or more locations comprises two locations located at or about opposed end portions of the support means.

Ideally, the opposed end portions of the support means are the front and rear end portions of the support means.

Preferably, the restraining means being operable to releasably secure the object to the support means, the restraining means comprising mechanical fastening means provided between the support means and the object.

Ideally, the mechanical fastening means comprises quick release mechanical fastening means.

Ideally, the mechanical fastening means comprising anchor components located at tow/each corners of the support means.

Ideally, the restraining means comprise one or more of belts, ropes, cords, and chains.

Preferably, the restraining means comprises an object restraining means for restraining the object to the support means.

Preferably, the object restraining means comprises a plurality of one or more of belts, ropes, cords, and chains or any other suitable mechanical fastening arrangement for restraining the object to the anchor components of the support means.

Preferably, the displacement mechanism comprises a lifting mechanism, the lifting mechanism being operable to raise and/or lower the support means.

Ideally, the lifting mechanism is operable to raise the support means from the loading position and/or lower the support means towards the loading position.

Ideally, the lifting mechanism is operable between the movable support platform and the rails.

Preferably, the lifting mechanism is operable between the movable support platform and the carriage means.

Ideally, the lifting mechanism is operable between the movable support platform and the movable chassis.

Preferably, the lifting mechanism is operable between the movable support platform and the cross member beam.

Ideally, the lifting mechanism is attachable to a rear end of the vehicle.

Preferably, the lifting mechanism is attachable to the inside of the vehicle.

Preferably, the home/transit position is inside a rear end compartment of a vehicle.

Preferably, the container is a vehicle.

Ideally, the vehicle is a motor vehicle.

Preferably, the vehicle is a truck, sports utility vehicle (SUV), passenger van, commercial van, bus, pick up, lorry, boat or ship.

Ideally, the object comprises goods for transport.

Ideally, when in the loading position, the support means is generally level with the ground.

Preferably, when in the home/transit position, the support means is generally level with the floor of the container.

Ideally, the displacement mechanism comprises a drive means for moving the support means between the outside and the inside of the container.

Preferably, the displacement mechanism comprises a drive means for moving the support means between the outside and the inside of the container.

In one embodiment, the drive means comprises a chain and preferably a rigid chain drive system.

In another embodiment, the drive means comprises a double acting hydraulic cylinder assembly.

Ideally, the double acting hydraulic cylinder assembly is a multi-stage double acting hydraulic cylinder assembly, most preferably a six stage double acting hydraulic cylinder assembly.

Ideally, a portion of the support means comprises an actuatable ramp section.

Preferably, the actuatable ramp section is pivotally moveable to adjust the angle of the ramp with respect to the support surface.

Ideally, when in the home/transit position, the displacement mechanism is entirely contained within the container.

Ideally, the container may be open such as a pick up truck or enclosed such has a box van.

Ideally, the compartment may be open or enclosed.

The skilled man will appreciate that all preferred or optional features of the invention described with reference to only some aspects or embodiments of the invention may be applied to all aspects of the invention.

It will be appreciated that optional features applicable to one aspect of the invention can be used in any combination, and in any number. Moreover, they can also be used with any of the other aspects of the invention in any combination and in any number. This includes, but is not limited to, the dependent claims from any claim being used as dependent claims for any other claim in the claims of this application.

The invention will now be described with reference to the accompanying drawings which shows by way of example only four embodiments of an apparatus in accordance with the invention.

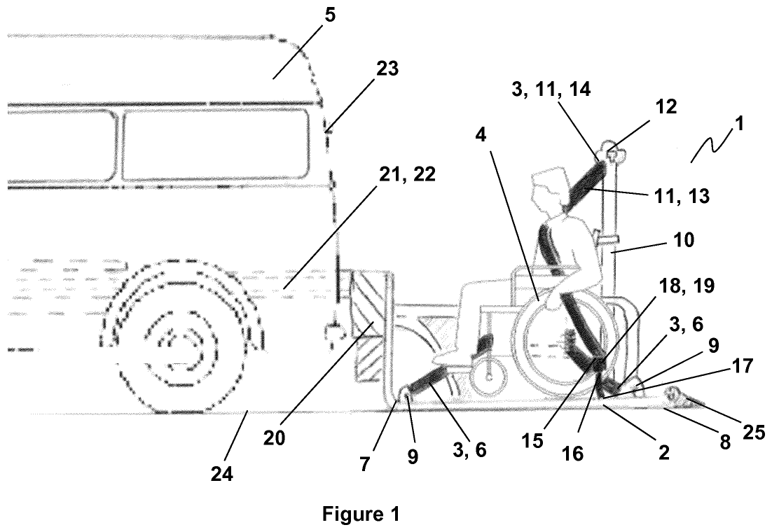

FIG. 1 is a schematic side view of the present invention in the loading position.

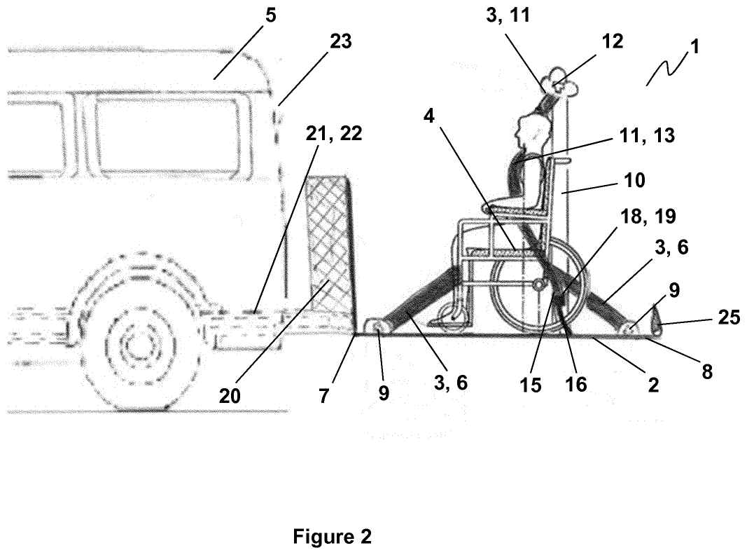

FIG. 2 is a schematic side view of the present invention in a transitional position between the loading position and the home/transit position;

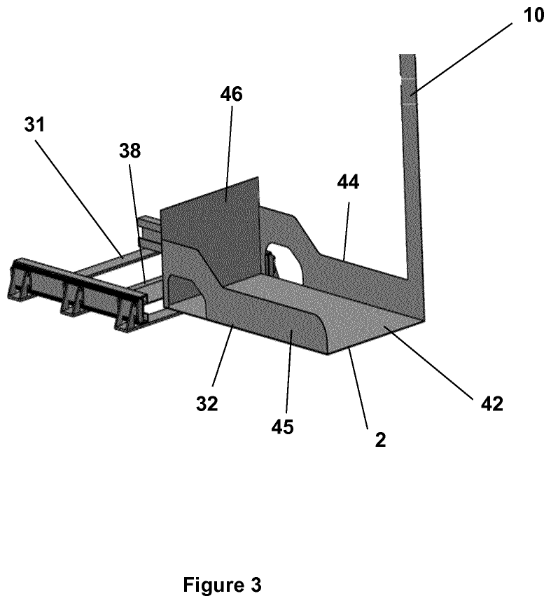

FIG. 3 is a perspective view of a displacement mechanism and movable support platform;

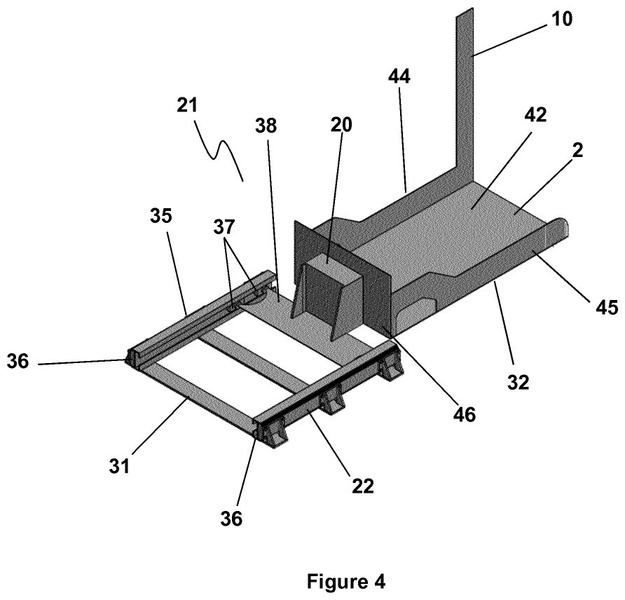

FIG. 4 is a second perspective view of the displacement mechanism and movable support platform;

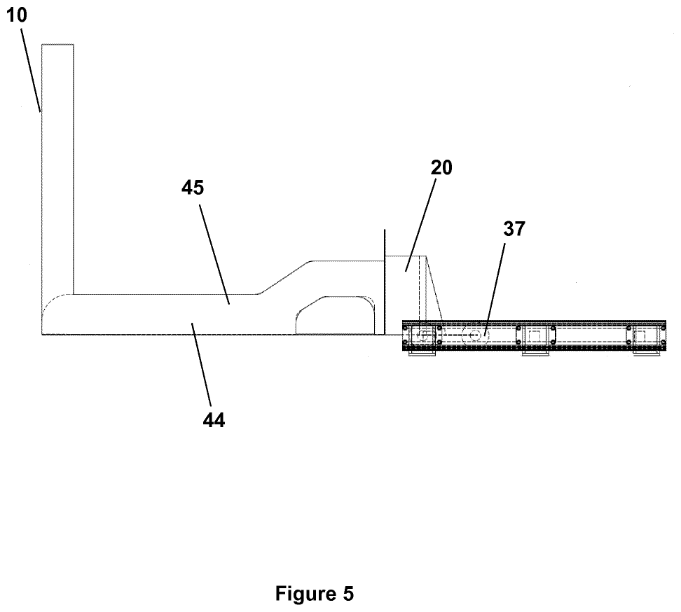

FIG. 5 is a side view of the displacement mechanism and movable support platform;

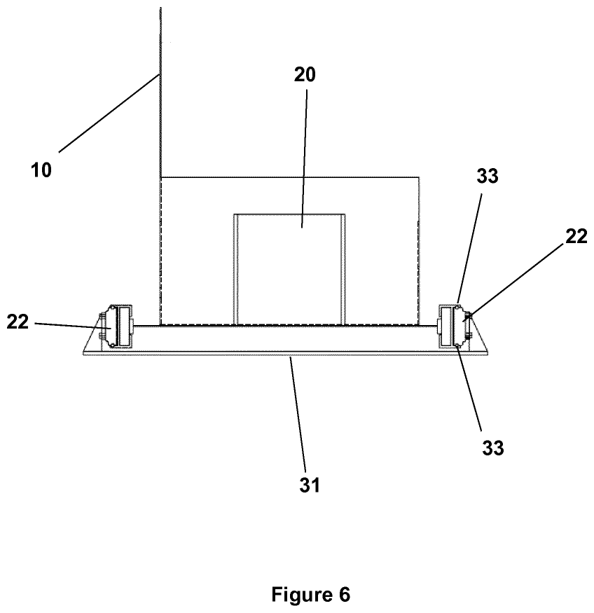

FIG. 6 is an end view of the displacement mechanism and movable support platform;

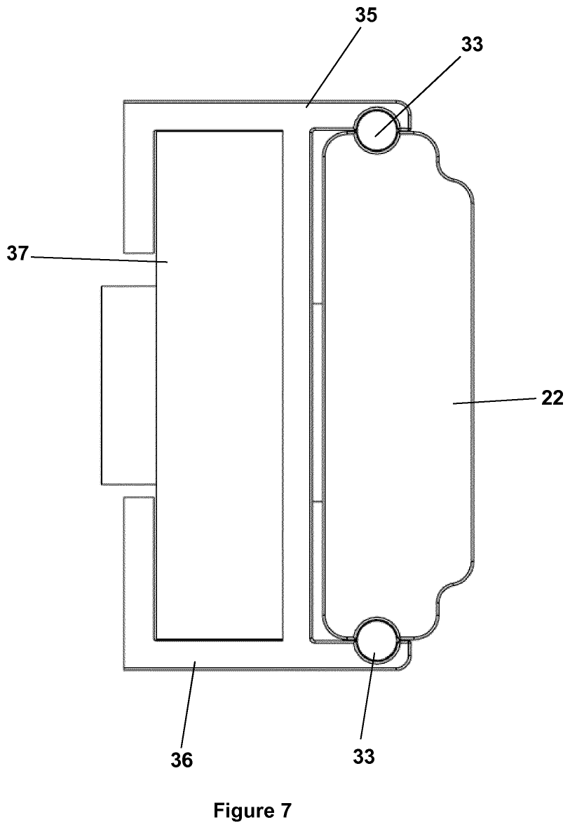

FIG. 7 is an end view of a bearing arrangement of the displacement mechanism;

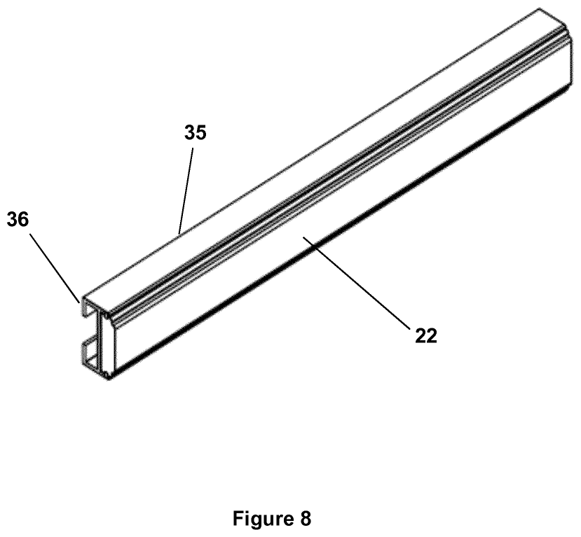

FIG. 8 is a first perspective view of the bearing arrangement, fixed rail and slidable rail;

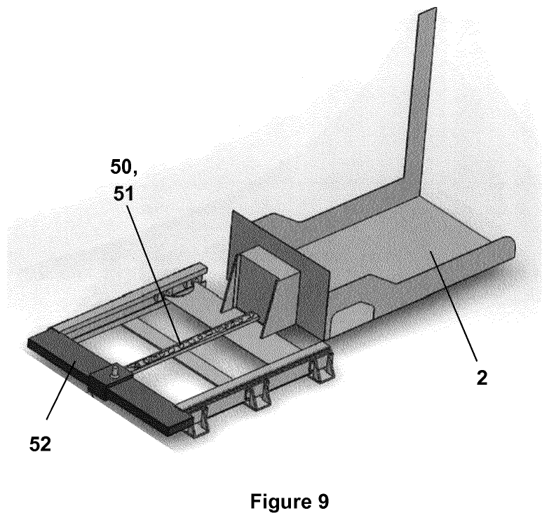

FIG. 9 is a perspective view of one embodiment of the drive system;

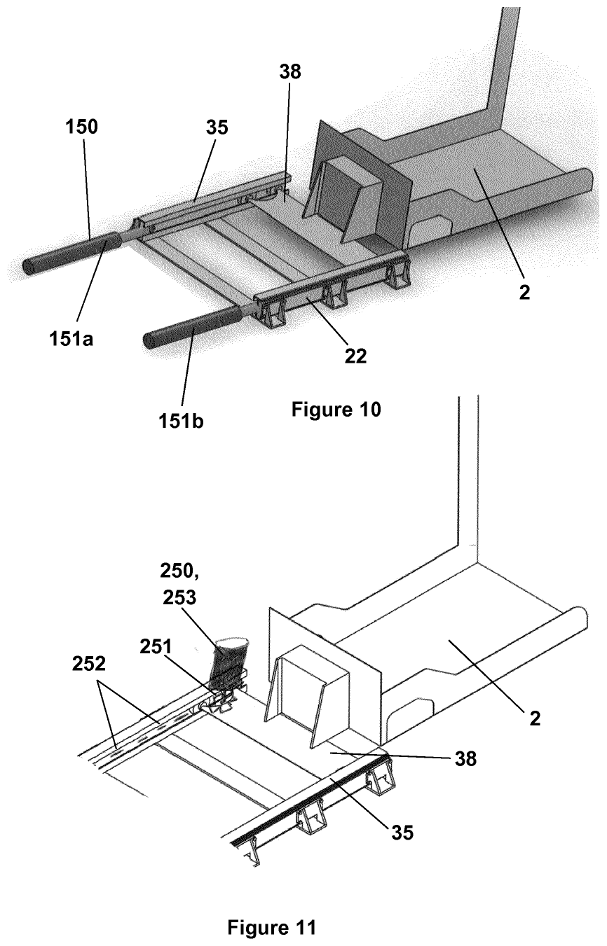

FIG. 10 is a perspective view of a part of a second embodiment of the drive system;

FIG. 11 is a perspective view of a second part of the second embodiment of the drive system;

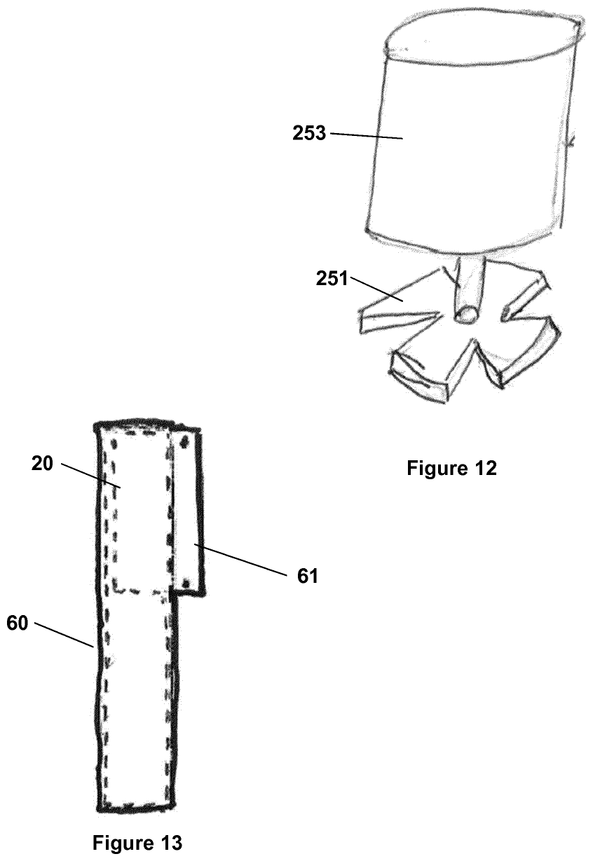

FIG. 12 is an expanded view of a part of the second embodiment of the drive system;

FIG. 13 is a side elevation view of the lifting mechanism according to the invention;

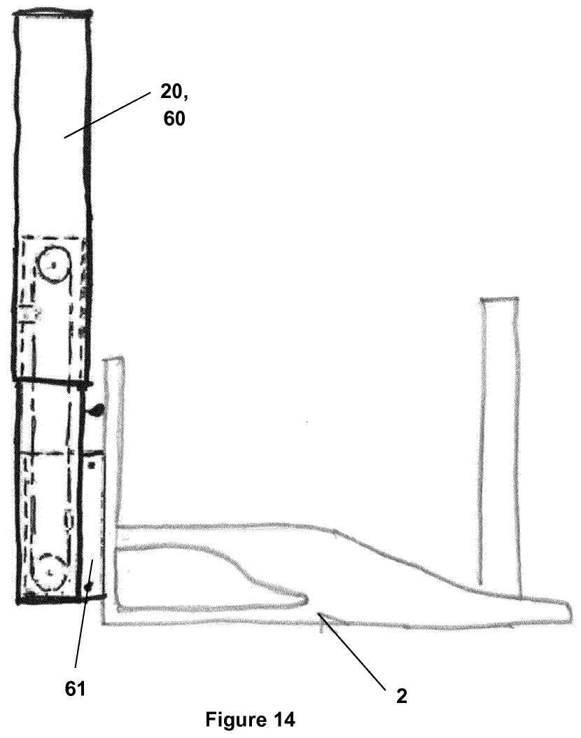

FIG. 14 is a second side elevation view of the lifting mechanism according to the invention;

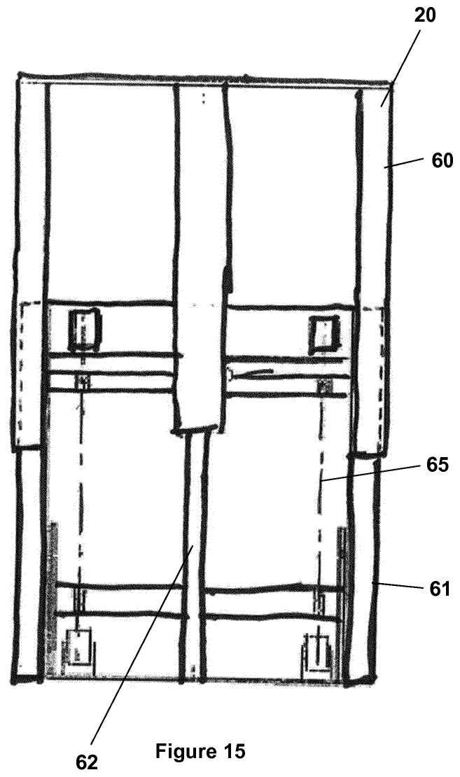

FIG. 15 is a front elevation view of the lifting mechanism;

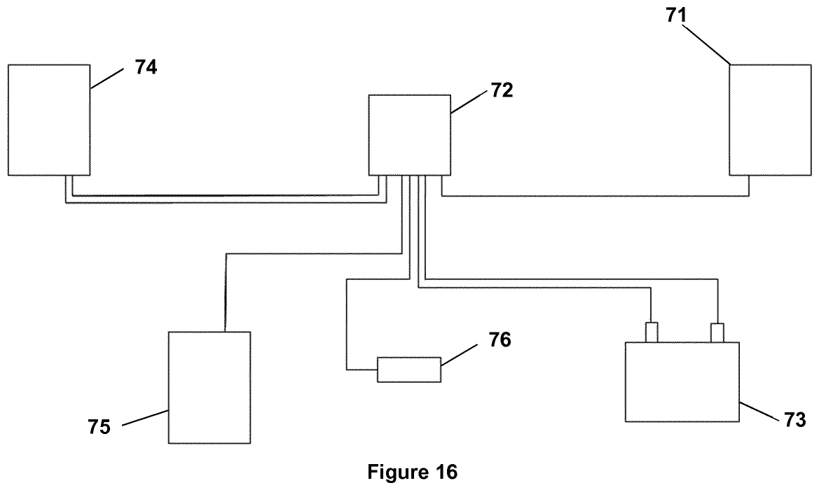

FIG. 16 is a schematic view of the control system for the displacement mechanism and/or the vehicular lift.

In the drawings, there is shown a vehicular lift indicated generally by the reference numeral 1. The vehicular lift 1 has a support arrangement 2 and a securing mechanism 3, 9 for securing an object 4 (such as a wheelchair) to the support surface 2. The support arrangement 2 is moveable between a loading position outside of a vehicle 5 (FIG. 1) and a home/transit position (not shown) inside the vehicle 5. The securing mechanism 3 securely holds the object 4 in place as the support arrangement 2 moves between the loading position (FIG. 1) and the home/transit position (not shown).

The securing mechanism 3 is the primary means for securing the object 4 in place within the vehicle 5. Therefore, additional securing components are not required in the vehicle 5 to secure the object 4 in place within the vehicle 5. The securing mechanism 3 has restraining components 6, 9, 11.

The restraining components 6, 9, 11 being operable to releasably secure the object 4 to four locations on the support arrangement 2. The four locations on the support arrangement 2 are spaced apart from one another in the corners of the support arrangement 2. The restraining components 6, 9, 11 being operable to releasably secure the object 4 to the support arrangement 2, the restraining components 6, 9, 11 comprising mechanical fastening members 6 provided between the support arrangement 2 and the object 4 in this case a wheelchair. The mechanical fastening members 6, 9 comprise quick release mechanical fastening members such as straps with spring loaded clasps or catches. The mechanical fastening members 6, 9 have anchor components 9 located at two/each corners of the support arrangement 2. Advantageously, this avoids any collisions between the object/wheel chair 4 and the anchor components 9 during placing the wheel chair 4 onto the support arrangement 2. The mechanical fastening arrangement is a wheel chair docking station. The support arrangement 2 has two or more births for supporting two or more objects 4 such as wheel chairs.

The restraining components 6, 9, 11 have one or more of belts, ropes, cords, and chains. The restraining components 6, 9 are object restraining components for restraining the object 4 to the support arrangement 2. The object restraining components are four belts, ropes, cords, or chains or any other suitable mechanical fastening arrangement for restraining the object 4 to the anchor components 9 of the support arrangement 2.

The restraining components 6, 9, 11 also have person restraining components 11 for restraining a person within the wheel chair 4. The vehicular lift 1 has an upstanding post 10 attached to the support arrangement 2. The restraining components 6, 9, 11 have an upstanding post 10 attached to the support arrangement 2. The person restraining component 11 extends from a portion of the upstanding post 10 to the support arrangement 2, the person restraining component 11 being operable to releasably secure the person in the wheelchair 4 to the support arrangement 2. The person restraining component 11 extends from a top end portion of the upstanding post 10 to the support arrangement. The person restraining component is a seat belt arrangement. The seat belt arrangement being operable between the upstanding post 10 and the support arrangement 2.

The seat belt arrangement having a reel 12 fastened to a portion of the upstanding post 10, the reel component 12 having a belt 13 wound thereon with at least one tongue 15 mounted on the belt 13, and a buckle component 18 having a first end 16 fastened to the support arrangement 2 on an opposite side of the support arrangement 2 to the upstanding post 10 and a second free end 19 for receiving the tongue 15. The seat belt arrangement has a second buckle component mounted lower down on the upstanding post 10 or on the same side of the support arrangement 2 to the upstanding post 10. The seat belt arrangement has a second tongue component 15 mounted on the belt 13 for engagement with the second buckle for creating a three point seat belt arrangement. The upstanding post 10 is located at or about the rear end portion of the support arrangement 2. The seat belt arrangement having a second reel fastened to a portion of the upstanding post or on the same side of the support means to the upstanding post.

The vehicular lift 1 further has a lifting mechanism 20 as illustrated in FIGS. 13 to 15. The lifting mechanism 20 is operable to raise and/or lower the support arrangement 2 from and/or towards the loading position (see FIG. 1 and FIG. 2). The lifting mechanism has a first anchor arrangement mounted on a fixed part 60 of the vehicular lift or vehicle at or above the level of the floor of the vehicle and a second anchor part mounted on the movable part 61 of the support platform 32. An adjustable length actuator, being a double-acting hydraulic ram 62, is mounted between the two anchor points to allow the movable support platform 32 to be moved up and down between the floor of the vehicle and the ground. The lifting mechanism 20 further has a chain arrangement 65 for further moving the moveable support platform 32, thereby increasing the total distance the lifting mechanism 20 can move the moveable support platform 32 beyond that of the distance moveable by the hydraulic ram 62 alone.

The vehicular lift 1 also has a lateral displacement mechanism 21. The lateral displacement mechanism 21 is operable to move the support surface 2 into/out of the vehicle towards and away from the home/transit position (not shown). The lateral displacement mechanism 21 has two spaced apart rails 22 which are attached to the chassis 31 of the vehicle 5. The two rails 22 are attached to the chassis 31 of the vehicle 5 in one embodiment and in another embodiment of vehicular lift 1, the two rails 22 rails are integrally formed with the chassis 31 of the vehicle 5. The two rails 22 are spaced apart a suitable distance to allow stable support for the transfer of the support surface 2 and the wheelchair 4 and occupant between the home/transit position and loading position. The displacement mechanism 11 also has a movable support platform 32. The displacement mechanism 11 has an assembly for movably mounting the movable support platform 32 on the pair of spaced apart rails 22 formed/attached with the chassis 31 of the vehicle 5. The movable mounting assembly has a bearing arrangement 33, see especially FIG. 7 operable between the movable support platform 32 and the pair of spaced apart rails 22. The bearing arrangement 33 allowing the movable support platform 32 to move between a position inside and outside of the vehicle 5. The movable mounting assembly has a pair of slidable rails 35 operably coupled to the fixed rails 22 via the bearing arrangement 33. The pair of slidable rails 35 have a pair of mutually opposing channels 36 for receiving a pair of carriage means/wheels or rollers 37 with the movable support platform 32 being mounted on the carriage means/wheels or rollers 37. The movable support platform 32 is mechanically coupled to the carriage means 37 by a movable chassis 38. The movable chassis 38 is provided by a cross member beam. The cross member beam 38 is a structural support plate member. The carriage arrangement 37 is movably/rotatably mounted at or about the four corners of the cross member beam 38. The carriage arrangement 37 has four roller wheels 37, two of which are formed for rolling along each mutually opposing channel 36 of the slidable rails 35. The channels 36 of the movable rails 35 allow the carriage arrangement 37 of the movable support platform 32 to move relative to both the fixed rails 22 and the movable rails 35. Advantageously, this provides additional travel for the movable support platform 32 whilst avoiding overextension and thus additional stresses being applied to the displacement mechanism 11. The slidable rails 35 travel along a part of the length of the fixed rails 22, up to 70% of the length of the fixed rails 22, or up to 50% of the length of the fixed rails 22 or up to 30% of the length of the fixed rails 22. The lifting mechanism 20 is operable between the movable support platform 32 and the rails 22, 35. More specifically, the lifting mechanism 20 is operable between the movable support platform 32 and the cross member beam 38. The support surface 2 is provided by the uppermost surface of the base member 42 of the movable support platform 32.

The movable support platform 32 has a peripheral safety guard mechanism 44. The peripheral safety guard mechanism 41 comprises a pair of lateral guard members 45 on two opposing lateral sides of the movable support platform 32 and a rear guard member 46. The guard members 45, 46 act as a barrier to prevent the wheelchair 4 from extending beyond a safe position on the support surface 2 of the movable support platform 32.

The vehicular lift 1 is attachable to a rear end of the vehicle 23 and the home/transit position (not shown) is inside a rear end compartment of the vehicle 5. Further, when in the home/transit position (not shown), the vehicular lift 1 is entirely contained within the vehicle 5. The vehicle 5 is a motor vehicle and the object 4 is a wheelchair occupied by a user (as shown in the drawings) or not.

When in the loading position (FIG. 1), the support surface 2 is generally level with the ground 24 and when in the home/transit position (not shown), the support surface 2 is generally level with the floor (not shown) of the vehicle 5.

The rear end portion 8 of the support surface 2 has an actuatable ramp section 25 which is pivotally moveable to adjust the angle of the ramp 25 with respect to the support surface 2.

In use, an operator positions the wheelchair in close proximately to the vehicle 5 and activates the vehicular lift 1 to move the support arrangement 2 outside the vehicle or outside of the boundary of the vehicle for pickups and the like and to lower the support arrangement 2 into the loading position. Once in the loading position the actuatable ramp section 25 is adjusted into a loading position (see FIG. 1). The operator then pushes the wheelchair 4 up the ramp section 25 and upon the support surface 2 of the vehicular lift 1. Once in position the wheelchair is secured to the support platform by securing mechanism 3 via restraining components 3, 6 (FIG. 1) and the ramp section 25 is readjusted (to its locked position shown in FIG. 2). The lifting mechanism 20 raises the support surface 2 off the ground (FIG. 2). Subsequently, the lateral displacement mechanism 21 moves the support surface 2 into the vehicle 5 towards the home/transit position (not shown). It will be appreciated that a reversal of these steps take place to disembark the wheelchair user from the vehicle 5.

In relation to the separable invention relating to the displacement mechanism for moving goods into and out of a container, the displacement mechanism 21 is operable to move the support surface 2 into/out of a container towards and away from the home/transit position (not shown). The lateral displacement mechanism 21 has two spaced apart rails 22 which are attached to the chassis/floor/support structure 31 of the container. The two rails 22 are attached to the chassis/floor/support structure 31 of the container in one embodiment and in another embodiment, the two rails 22 rails are integrally formed with the chassis/floor/support structure 31 of the container. The two rails 22 are spaced apart a suitable distance to allow stable support for the transfer of the support surface 2 between the home/transit position and loading position. The displacement mechanism 11 also has a movable support platform 32. The displacement mechanism 11 has an assembly for movably mounting the movable support platform 32 on the pair of spaced apart rails 22 formed/attached with the chassis/floor/support structure of the container. The movable mounting assembly has a bearing arrangement 33, see especially FIG. 5 operable between the movable support platform 32 and the pair of spaced apart rails 22. The bearing arrangement 33 allowing the movable support platform 32 to move between a position inside and outside of the container. The movable mounting assembly has a pair of slidable rails 35 operably coupled to the fixed rails 22 via the bearing arrangement 33. The pair of slidable rails 35 have a pair of mutually opposing channels 36 for receiving a pair of carriage means/wheels or rollers 37 with the movable support platform 32 being mounted on the carriage means/wheels or rollers 37. The movable support platform 32 is mechanically coupled to the carriage means 37 by a movable chassis 38. The movable chassis 38 is provided by a cross member beam. The cross member beam 38 is a structural support plate member. The carriage arrangement 37 is movably/rotatably mounted at or about the four corners of the cross member beam 38. The carriage arrangement 37 has four roller wheels 37, two of which are formed for rolling along each mutually opposing channel 36 of the slidable rails 35. The channels 36 of the movable rails 35 allow the carriage arrangement 37 of the movable support platform 32 to move relative to both the fixed rails 22 and the movable rails 35. Advantageously, this provides additional travel for the movable support platform 32 whilst avoiding overextension and thus additional stresses being applied to the displacement mechanism 11. The slidable rails 35 travel along a part of the length of the fixed rails 22, up to 70% of the length of the fixed rails 22, or up to 50% of the length of the fixed rails 22 or up to 30% of the length of the fixed rails 22.

The displacement mechanism 21 further has a lifting mechanism 20. The lifting mechanism 20 is operable to raise and/or lower the support arrangement 2 from and/or towards a loading position. The lifting mechanism 20 comprises a first anchor arrangement mounted on the displacement mechanism 21 or a fixed part of the container at or about the level of the floor of the container and a second anchor part mounted on the movable support platform. An adjustable length actuator is mounted between the two anchor points to allow the movable support platform to be moved up and down between the floor of the container and the ground. The lifting mechanism 20 is operable between the movable support platform 32 and the rails 22, 35. More specifically, the lifting mechanism 20 is operable between the movable support platform 32 and the cross member beam 38. The support surface 2 is provided by the uppermost surface of the base member 42 of the movable support platform 32.

The movable support platform 32 has a peripheral safety guard mechanism 44. The peripheral safety guard mechanism 41 comprises a pair of lateral guard members 45 on two opposing lateral sides of the movable support platform 32 and a rear guard member 46. The guard members 45, 46 act as a barrier to prevent the goods from extending beyond a safe position on the support surface 2 of the movable support platform 32.

The displacement mechanism 21 is attachable to a rear end of a vehicle and the home/transit position (not shown) is inside a rear end compartment of the vehicle 5. Further, when in the home/transit position (not shown), the displacement mechanism 21 is entirely contained within the vehicle 5.

When in the loading position (FIG. 1), the support surface 2 is generally level with the ground 24 and when in the home/transit position (not shown), the support surface 2 is generally level with the floor (not shown) of the container such as a vehicle.

The rear end portion 8 of the support surface 2 has an actuatable ramp section 25 which is pivotally moveable to adjust the angle of the ramp 25 with respect to the support surface 2.

In use, an operator positions the goods in close proximately to a container such as a vehicle and activates the displacement mechanism 21 to move the support arrangement 2 outside the container or outside of the boundary of the vehicle for pickups and the like and to lower the support arrangement 2 into the loading position. Once in the loading position an actuatable ramp section is adjusted into a loading position. The operator then moves the goods onto the ramp section and onto the support surface 2. Once in position the goods are secured to the support platform by securing mechanism via restraining components and the ramp section is readjusted. The lifting mechanism 20 raises the support surface 2 off the ground (FIG. 2). Subsequently, the lateral displacement mechanism 21 moves the support surface 2 into the container towards the home/transit position (not shown).

In FIG. 9 there is shown a drive system indicated by reference numeral 50. The drive system 50 has a chain 51, the chain being of the type where adjacent links in the chain form a rigid rod when they extend in alignment with one another and they break back into independently movable links when they are bent out of alignment with one another via a mechanism for steering the links out of a rectilinear path of travel into a curvilinear path of travel. The chain 50 is operably coupled between the support arrangement 2 and a housing 52 for the chain 50. The drive system 50 further involves an electric motor and a gearbox disposed within the housing 52 for powering movement of the chain 50.

In use, the motor is operated thereby dispensing the chain 50 out of the housing 52 to drive the support arrangement 2 out of the vehicle. Operation of the motor is then reversed for reeling the chain 52 back into the housing and to pull the support arrangement 2 back into the vehicle.

A part of a second embodiment of a drive system is shown in FIG. 10 and is indicated by reference numeral 150. The drive system 150 involves two double-acting hydraulic rams 151a, 151b operably coupled to the pair of slidable rails 35 and operable to move the slidable rails 35 relative to the fixed rails 22.

In use, the support arrangement 2 can be moved out of a vehicle by operating the double-acting hydraulic rams 151a, 151b to move the slidable rails 35 out of the vehicle. To return the support arrangement 2 into the vehicle the movement of the double-acting hydraulic rams 151a, 151b are reversed.

A second part of the second embodiment of drive system indicated by reference numeral 250 is shown in FIG. 11. In this embodiment there is a driven toothed wheel 251 mounted on the movable chassis 38. The slidable rails 35 have a plurality of slots 252 formed along the slidable rails 35 for receiving teeth of the drive wheel 251 for driving the movable chassis 38 along the slidable rails 35. The drive system 250 involves an electric motor 253 for powering movement of the driven toothed wheel 251.

In use, the motor 253 is operated which causes the drive wheel 251 to rotate. The teeth of the wheel 251 engage with the slots 252 formed along the slidable rails 35 and therefore the wheel 251 moves along the slidable rails 35 and the movable chassis 38 is correspondingly moved. The direction of rotation of the motor 253 can be reversed to move the movable chassis 38 in the reverse direction.

Referring to FIG. 16 of the drawings there is shown a control system for the overall control of the vehicular lift or displacement mechanism for moving goods into and out of a container. The system has a hand held controller 71 in this case a four way controller for providing up down and forward reverse signals. The controller 71 is connected to a relay box 72 in this case a four way relay box 72. The relay box 72 is connected to the battery 73 of the vehicle. Also connected to the relay box 72 is the power source for the drive system 74 to drive a motor and gearbox for a chain in a first embodiment of drive arrangement or a hydraulic cylinder and secondary actuator drive means in a second embodiment of drive system 74. The hydraulic pump 75 for the hydraulic actuator of the lifting mechanism is also connected to the relay box 72 and a release valve 76 for releasing the hydraulic pressure of the hydraulic pump 75 is also operably coupled to the relay box 72.

In use, an operator opens the back door of the vehicle and takes the hand held controller 71 in their hand. The hand held controller 71 is powered from the battery of the vehicle 73 and the hand held controller 71 is wired to a relay box 72 for switching between the drive system 74 and the vehicular lifting mechanism 75, 76. The user presses a forward button on the hand held controller 71 which switches on the power to the electric motor 74 in the housing for the chain and this motor 74 starts to drive the chain out of the housing. As the chain is connected to the support means the chain drives the support means forward from the transit position in the vehicle towards the rear end of the vehicle. In the embodiment where a pair of hydraulic cylinders are connected to the movable rails, a hydraulic pump is operated in this embodiment which extends the hydraulic rams moving the movable rails along the fixed rails. In this embodiment a secondary actuator is operable between the movable chassis and the movable rails and so this embodiment will require this secondary actuator to be operably coupled to the circuit.

In the chain embodiment, the chain is of the type where adjacent links in the chain form a rigid rod when they extend in alignment with one another and they break back into independently movable links when they are bent out of alignment with one another via a mechanism for steering the links out of a rectilinear path of travel into a curvilinear path of travel.

The force acting on the support means causes extension of the displacement mechanism as the movable rails move along the fixed rails as a result of the force applied to the support means via the chain driven by the electric motor or hydraulic cylinders.

When the movable rails reach the end of their travel relative to the fixed rails, the support means can travel along the movable rails via a carriage unit again as a result of the force applied to the support means via the chain driven by the electric motor or the secondary actuator.

At the point where the support means namely the platform for supporting the wheel chair or goods is clear of the rear end of the vehicle, the operator releases the forward motion control button of the hand held controller 71 and presses a lower control button which releases a pressure release valve 76 which allows the hydraulic oil pressure to lower and the hydraulic actuator of the lifting mechanism to extend and lower to the ground. Goods are securely attached to or released from the support platform via the restraining means. To raise the support platform the operator presses the raise button and the hydraulic pump motor pumps hydraulic oil into the actuator raising the hydraulic pressure causing the hydraulic actuation means to retract and raise the support platform of vehicular lift. The operator then presses the reverse button of the controller 71 and the drive system pulls the platform into the transit position in the vehicle.

In relation to the detailed description of the different embodiments of the invention, it will be understood that one or more technical features of one embodiment can be used in combination with one or more technical features of any other embodiment where the transferred use of the one or more technical features would be immediately apparent to a person of ordinary skill in the art to carry out a similar function in a similar way on the other embodiment.

In the preceding discussion of the invention, unless stated to the contrary, the disclosure of alternative values for the upper or lower limit of the permitted range of a parameter, coupled with an indication that one of the said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The features disclosed in the foregoing description or the following drawings, expressed in their specific forms or in terms of a means for performing a disclosed function, or a method or a process of attaining the disclosed result, as appropriate, may separately, or in any combination of such features be utilised for realising the invention in diverse forms thereof as defined in the appended claims.

1.-44. (canceled)

45. A vehicular lift comprising a support means and a means for securing an object to the support means, the support means being moveable between a loading position outside of a vehicle and a home/transit position inside the vehicle.

46. The vehicular lift as claimed in claim 45, wherein the means for securing holds the object securely in place as the support means moves between the loading position and the home/transit position.

47. The vehicular lift as claimed in claim 45, wherein the support means comprises a support surface.

48. The vehicular lift as claimed in claim 45, wherein the means for securing is the primary means for securing the object in place within the vehicle.

49. The vehicular lift as claimed in claim 45, wherein additional means for securing are not required in the vehicle to secure the object in place within the vehicle.

50. The vehicular lift as claimed in claim 45, wherein the means for securing comprises one or more restraining means.

51. The vehicular lift as claimed in claim 50, wherein the restraining means are operable to releasably secure the object to the support means.

52. The vehicular lift as claimed in claim 51, wherein the restraining means are operable to releasably secure the object to the support means, the restraining means comprising mechanical fastening means provided between the support means and the object.

53. The vehicular lift as claimed in claim 52, wherein the mechanical fastening means comprises a wheel chair docking station.

54. The vehicular lift as claimed in claim 45, wherein the support means comprises two or more births for supporting two or more objects such as wheel chairs.

55. The vehicular lift as claimed in claim 45, wherein the vehicular lift further comprises a displacement mechanism, the displacement mechanism being operable to move the support means between a position outside of a vehicle and a home/transit position inside the vehicle.

56. The vehicular lift as claimed in claim 55, wherein the displacement mechanism comprises spaced apart elongate guide means fixed to the vehicle and parallel to the longitudinal axis thereof, movable elongate guide means movably mounted on the fixed guide means via bearing means facilitating the movement, carriage means movably mounted on and between the movable elongate guide means so as to be movable relative to both the fixed and movable elongate guide means, the support means being operably coupled to the carriage means.

57. The vehicular lift as claimed in claim 55, wherein the support means comprises a movable support platform.

58. The vehicular lift as claimed in claim 57, wherein the displacement mechanism having bearing means and carriage means for movably mounting the movable support platform on the pair of spaced apart rails formed or attached with the chassis of the vehicle.

59. The vehicular lift as claimed in claim 58, wherein the bearing means and/or carriage means allowing the movable support platform to move between a position inside and outside of the vehicle.

60. The vehicular lift as claimed in claim 45, wherein the vehicular lift further comprises a lifting mechanism, the lifting mechanism being operable to raise and/or lower the support means.

61. The vehicular lift as claimed in claim 45, wherein the vehicular lift comprises a drive means for moving the support means between the outside and the inside the vehicle.

62. The vehicular lift as claimed in claim 61, wherein the drive means comprises a chain and preferably a rigid chain drive system.

63. The vehicular lift as claimed in claim 61, wherein the drive means comprises a double acting hydraulic cylinder assembly.

64. A vehicle comprising a compartment, the vehicle further comprising a vehicular lift, the vehicular lift comprising a support means and a means for securing an object to the support means, the support means being moveable between a loading position outside of the vehicle and a home/transit position inside the compartment of the vehicle.
